(19) United States
(12) Patent Application Publication
(10) Pub. No.: US 2008/0150243 A1
(43) Pub. Date: Jun. 26, 2008

(54) Plastic Snowboard and Its Manufacture Method

(76) Inventor: Aifu Shen, Ningbo (CN)

Correspondence Address: GLOBAL IP SERVICES, 7285 W. Eagle Court, Winton, CA, 95388, US

(21) Appl. No.: 11/753,808

(22) Filed: May 25, 2007

(30) Foreign Application Priority Data
Dec. 22, 2006 (CN) 200610155401.X

(51) Int. Cl. B62B 9/04

(52) U.S. Cl. 280/14.21; 264/48

(57) ABSTRACT

A manufacturing method of plastic snowboard featured by the steps as follows: making the inner core (3) in the shape of the product by steam heating in the foaming mold, manufacture of the bottom board (6), manufacture of the compound bottom board and the surface board (7), forming the surface board (7) and the compound bottom board, trimming, then sealing the edge of the product by hot melting to get the molded product. Compared with existing techniques, the advantages of this invention are that it firstly make the inner core in the shape of the product by steam heating in the foaming mold, which improves the impact resistance, and that the inner core acting as the framework is formed in the mold separately, making the framework of the inner core stronger, and that in case of external force, the inner core will have fine elastic deformation and stronger impact resistance, which prevents the product from deformation and thus greatly enhances the impact resistance of the product.

### CROSS REFERENCE TO THE RELATED PATENT APPLICATION

This application claims the priority of the Chinese patent application No. 200610155401.X, filing date of Dec. 22, 2006.

### FIELD OF THE INVENTION

This invention involves a kind of molded plastic snowboard, especially the manufacturing method of a kind of plastic snowboard.

### BACKGROUND OF THE INVENTION

There are diversified categories and types of snowboards at present, the Applicant applied at China Patent Bureau for the patent of “Molded Plastic Snowboard and Its Manufacturing Technique” under the patent number of 200510063363 on Apr. 8 2005, which disclosed a technique, i.e., the manufacturing method of said molded plastic snowboard, which consists of the following steps: slice the foaming PE material in pieces according to the required thickness for the snowboard as the inner core of the snowboard; the PE material slices are made into the bottom layer of the snowboard, which is then made into compound bottom board through heating, pressing and inner core adhesion; heat the compound bottom board to 80˜150° C. and maintain the temperature for 100˜15 minutes, after that place the bottom board into the mold, with the bottom of the board contacting the mold, and press on it, at the same time, carry out vacuum pumping in the space between the bottom and the mold, and then the bottom is molded; integrate the edge of the compound according to the pattern of the snowboard; apply hot melt glue on the bottom board before cover the PE film one it as the deck plane, then place the bottom board into the mold, allowing the deck plane contact the mold surface, and at the same time press on the undersurface and carry out vacuum pumping between the deck plane and the mold surface to mold the deck plane; trim the deck plane, seal the edge by hot melting for achieving the molded product, Therefore, its main technique include binding the inner core material with the bottom board and place them in the mold for forming before being made into finished products in the mold by stamping and binding. This technique is simple and provides fine connection between different parts so as to get products of different appearances. However, its disadvantage is that it's difficult to form products with more complex appearance and more exquisite structure, since the inner core acting as the framework of the structure is not formed in the mold separately, the inner core will most probably be asynchronous with the appearance and the framework will not be firm enough, in case of external force, the product is subject to deformation, moreover, the impact resist of the product will hardly be further improved. Therefore, this method still requires to be improved.

### SUMMARY OF THE INVENTION

The technical problem for this invention to solve is that to provide a kind of easy molding manufacture method of plastic snowboard with reasonable processes according to the aforesaid existing techniques, which can produce products not subject to distortion due to external force and with higher resistance to impact.

The technical solution adopted by this invention to solve the aforesaid technical problems is: Manufacturing method of this plastic snowboard, which is featured by the following steps:

a, make the inner core in the shape of the product by foaming of the plastic foam in the foaming mold;

b, take a plastic slice and apply a layer of PE material on the undersurface of the foamed plastic slice as the bottom board, and then apply a layer of glue on the upper surface of the foamed plastic slice;

c, heat the bottom board in the oven for 7˜15 minutes in the temperature of 130˜180° C., then take out the bottom board from the oven and place it in the mold, and then place the inner core on the bottom board, making the glue layer contact the inner core and apply pressure on it, at the same time, carry out vacuum pumping between the undersurface of the bottom board and the mold surface to mold the undersurface, the combination of the bottom board and the inner core forms the compound bottom board, after that, trim the excessive material of the bottom board;

d, take a plastic film and print patterns on the undersurface of it, adhere the undersurface of the printed plastic film to the upper surface of the foamed plastic slice by means of compound binding as the surface board and apply a layer of glue on the undersurface of the foamed plastic slice with a plastic film on it.

e, heat the surface board in the oven for 6˜15 minutes in the temperature of 120˜180° C., then take out the bottom board from the oven and place it in the mold, make the glue layer on the undersurface of the surface board contact the inner core of the upper surface of the compound bottom board and apply pressure on it, at the same time, carry out vacuum pumping between the surface board and the mold surface to mold the surface board and the compound bottom board;

f, and then trim the surface board, after that, seal the edge of the product by hot melting to get the formed product.

As further improvement, the materials for said inner core should be EPS, EPP or IXPE, EPS means expandable polystyrene, EPP means expandable polypropylene, IXPE means electronic cross-linked PE foam; said foamed plastic slices should be XPE or IXPE, XPE means cross-linked PE, IXPE means electronic cross-linked PE foam; PE means polyethylene; the thickness of said surface board and bottom board should be 2˜5 mm. When adopting IXPE material, the density should be 30˜60 Kg/m³.

Said glue layer should be hot melt glue layer as further improvement.

As further improvement, said inner core should be that made by means of steam heating of the foamed plastic into the shape of the product in the foaming mold; the undersurface of said foamed plastic slice should be applied with a layer of PE material with a coating machine.

Finally, the range of said pressure is 65˜100 T. Said vacuum-pumping intensity of pressure is 1×10⁵pa.

Compared with existing technologies, this invention has the following advantages: first, make the inner core in the shape of the product by steam heating in the foaming mold, the old technique is to bind the inner core material and the bottom board together, and then place it in the mold for molding before making it into the product in the mold by stamping and binding, while this technique is to make the inner core in the mold by foaming of the foaming materials first to form the inner core into the shape of the product in the mold, and then place it in the mold to be bound to the bottom board and surface board, moreover, this technique changed the PE materials used in the old technique into EPS (expandable polystyrene) materials, which have better impact resistance, and because the inner core acting as the framework is formed in the mold separately, the inner core is stronger, more easily formed and more reasonable, in case of external force, the inner core will have fine elastic deformation and stronger impact resistance, preventing the product form deformation, and with its impact resistance greatly improved, it is more suitable for molding of products with more complex appearance and more exquisite structure.

### BRIEF DESCRIPTION OF THE DRAWINGS

FIG. 1 shows the top view of the best mode of this invention;

FIG. 2 shows the sectional view according to A-A line in FIG. 1;

FIG. 3 is the amplified drawing of part I in FIG. 2.

FIG. 4 shows the mold connected with vacuum pump.

### DETAIL DESCRIPTION OF THE INVENTION

Detailed description of this invention is provided below in combination of attached drawings.

### EXAMPLE 1

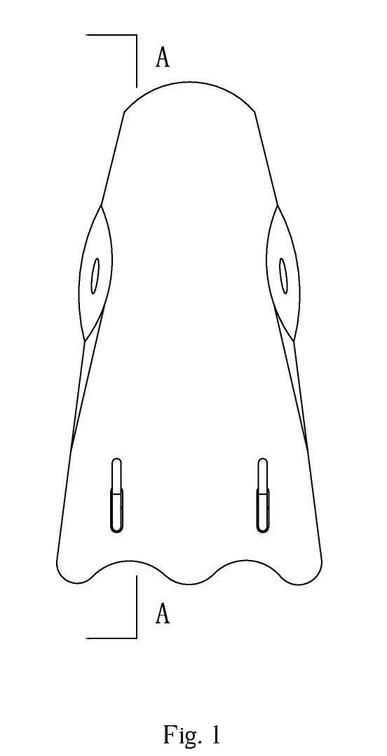

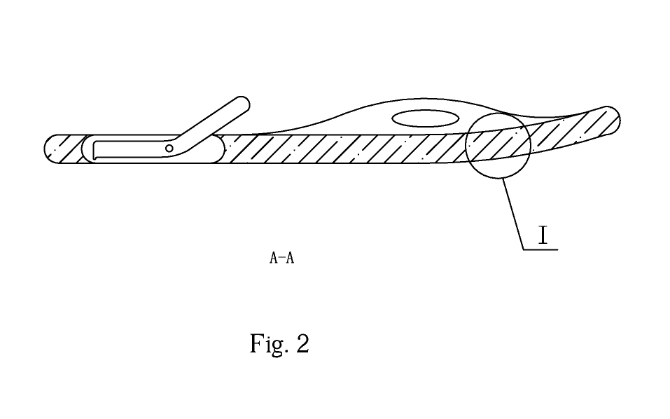

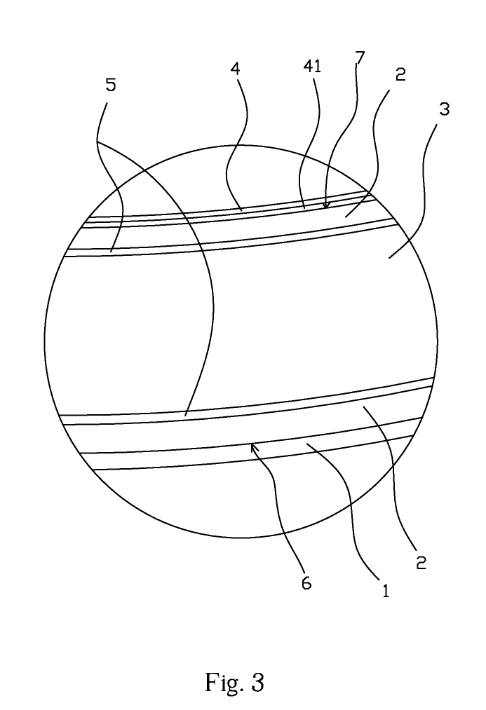

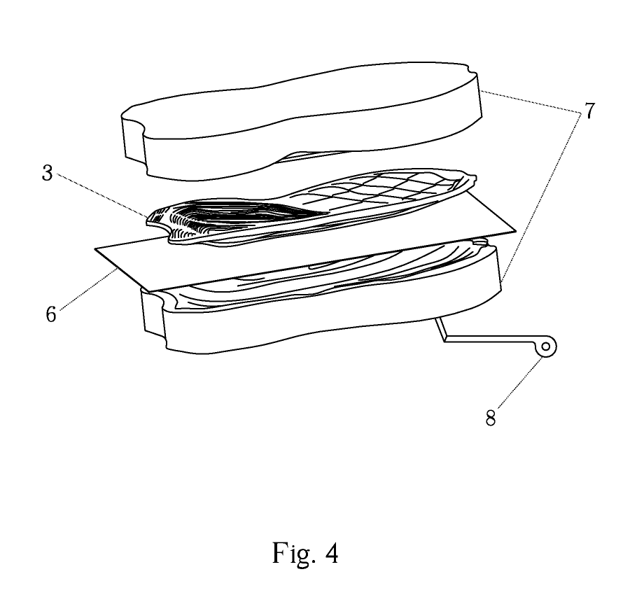

As shown in FIG. 1, FIG. 2, FIG. 3 and FIG. 4 the manufacturing method of plastic snowboard in this example consists of the following steps:

a, fill the foaming mold with EPS (expandable polystyrene) materials by steam heating to make the inner core 3 in the shape of the product;

b, XPE cross-linked PE foam slice 2, apply a layer of PE 1 material with a coating machine on the undersurface of the XPE cross-linked PE slice 2 as the bottom board 6, the coating machine should be JSLM65-1000 double-unwinding coating machine produced by Jiangyin City Jiangnan Light Industrial Machines Factory, and apply a hot melt glue layer 5 on the upper surface of the XPE foam slice 2;

c, heat the bottom board 6 in the oven for 7 minutes in the temperature of 130° C., then take out the bottom board 6 from the oven and place it in the mold 7, which is connected with vacuum pump 8. Place the inner core 3 onto the bottom board 6, making the glue layer 5 contact the inner core 3 and apply pressure on it, the applied pressure is 65˜100 T, at the same time, carry out vacuum pumping in the space between the bottom of the bottom board and the mold surface to form the undersurface, the intensity of pressure of the vacuum pumping is 1×10⁵pa, i.e., the combination of the bottom board 6 and the inner core 3 forms the compound bottom board, and then trim excessive bottom board materials for bottom board. The thickness of the bottom board 6 should be 2˜5 mm;

d, take a plastic film 4 and print patterns on the undersurface of it, adhere the undersurface of the printed plastic film to the upper surface of the XPE foamed plastic slice 2 by means of compound binding with the glue layer 41 as the surface board 7 and apply a glue layer 5 on the undersurface of the XPE cross-lined foam slice 2 with a plastic film on it;

e, heat the surface board 7 in the oven for 6˜15 minutes in the temperature of 120° C., then take out the surface board 7 from the oven and place it in the mold, and then make the glue layer 5 on the undersurface of the surface board 7 contact with the inner core 3 on the surface of the compound bottom board and apply pressure on it, the applied pressure is 65˜100 T, at the same time, carry out vacuum pumping in the space between the surface board 7 and the mold surface, the intensity of pressure of the vacuum pumping is 1×10⁵pa, i.e., therefore mold and combine the surface board and the compound bottom board. The thickness of the surface board 7 should be 2˜5 mm;

f, and then trim the surface board 7, after that, seal the edge of the product by hot melting to get the formed product.

Of course, besides EPS, the inner core 3 may adopts materials EPP or IXPE, EPP means expandable polypropylene, IXPE means electronic cross-linked PE foam. While for said foamed plastic slice 2, besides, XPE material, it can also adopts IXPE, IXPE means electronic cross-linked PE foam, and when adopting IXPE as the material, the density should be 30˜60 Kg/m³.

### EXAMPLE 2

As shown in FIG. 1, FIG. 2 and FIG. 3, the manufacturing method of plastic snowboard in this example consists of the following steps:

a, fill the foaming mold with EPS (expandable polystyrene) materials by steam heating to make the inner core 3 in the shape of the product;

b, XPE cross-linked PE foam slice 2, apply a layer of PE 1 material with a coating machine on the undersurface of the XPE cross-linked PE slice 2 as the bottom board 6, the coating machine should be JSLM65-1000 double-unwinding coating machine produced by Jiangyin City Jiangnan Light Industrial Machines Factory, and apply a hot melt glue layer 5 on the upper surface of the XPE foam slice 2;

c, heat the bottom board 6 in the oven for 7˜15 minutes in the temperature of 150° C., then take out the bottom board 6 from the oven and place it in the mold 7, and then place the inner core 3 onto the bottom board 6, making the glue layer 5 contact the inner core 3 and apply pressure on it, the applied pressure is 65·100 T, at the same time, carry out vacuum pumping in the space between the bottom of the bottom board and the mold surface to form the undersurface, the intensity of pressure of the vacuum pumping is 1×10⁵pa, i.e., the combination of the bottom board 6 and the inner core 3 forms the compound bottom board, and then trim the excessive material of the bottom board. The thickness of the bottom board 6 should be 2˜5 mm;

d, take a plastic film 4 and print patterns on the undersurface of it, adhere the undersurface of the printed plastic film to the upper surface of the XPE foamed plastic slice 2 by means of compound binding with the glue layer 41 as the surface board 7 and apply a glue layer 5 on the undersurface of the XPE cross-lined foam slice 2 with a plastic film on it;

e, heat the surface board 7 in the oven for 6˜15 minutes in the temperature of 160° C., then take out the surface board 7 from the oven and place it in the mold, and then make the glue layer 5 on the undersurface of the surface board 7 contact with the inner core 3 on the surface of the compound bottom board, make the glue layer 5 contact the inner core 3 and apply pressure on it, the applied pressure is 65˜100 T, at the same time, carry out vacuum pumping in the space between the surface board 7 and the mold surface, the intensity of pressure of the vacuum pumping is 1×10⁵pa, i.e., therefore mold and combine the surface board and the compound bottom board. The thickness of the surface board 7 should be 2˜5 mm;

f, and then trim the surface board 7, after that, seal the edge of the product by hot melting to get the formed product.

Of course, besides EPS, the inner core 3 may adopts materials EPP or IXPE, EPP means expandable polypropylene, IXPE means electronic cross-linked PE foam. While for said foamed plastic slice 2, besides, XPE material, it can also adopts IXPE, IXPE means electronic cross-linked PE foam, and when adopting IXPE as the material, the density should be 30˜60 Kg/m³.

### EXAMPLE 3

As shown in FIG. 1, FIG. 2 and FIG. 3, the manufacturing method of plastic snowboard in this example consists of the following steps:

a, fill the foaming mold with EPS (expandable polystyrene) materials by steam heating to make the inner core 3 in the shape of the product;

b, XPE cross-linked PE foam slice 2, apply a layer of PE 1 material with a coating machine on the undersurface of the XPE cross-linked PE slice 2 as the bottom board 6, the coating machine should be JSLM65-1000 double-unwinding coating machine produced by Jiangyin City Jiangnan Light Industrial Machines Factory, and apply a hot melt glue layer 5 on the upper surface of the XPE foam slice 2;

c, heat the bottom board 6 in the oven for 7 minutes in the temperature of 180° C., then take out the bottom board 6 from the oven and place it in the mold 7, and then place the inner core 3 onto the bottom board 6, making the glue layer 5 contact the inner core 3 and apply pressure on it, the applied pressure is 65˜100 T, at the same time, carry out vacuum pumping in the space between the bottom of the bottom board and the mold surface to form the undersurface, the intensity of pressure of the vacuum pumping is 1×10⁵pa, i.e., the combination of the bottom board 6 and the inner core 3 forms the compound bottom board, and then trim the excessive material for bottom board. The thickness of the bottom board 6 should be 2˜5 mm;

d, take a plastic film 4 and print patterns on the undersurface of it, adhere the undersurface of the printed plastic film to the upper surface of the XPE foamed plastic slice 2 by means of compound binding with the glue layer 41 as the surface board 7 and apply a glue layer 5 on the undersurface of the XPE cross-linked PE foam slice 2 with a plastic film on it;

e, heat the surface board 7 in the oven for 6˜15 minutes in the temperature of 180° C., then take out the surface board 7 from the oven and place it in the mold, and then make the glue layer 5 on the undersurface of the surface board 7 contact with the inner core 3 on the surface of the compound bottom board and apply pressure on it, the applied pressure is 65˜100 T, at the same time, carry out vacuum pumping in the space between the surface board 7 and the mold surface, the intensity of pressure of the vacuum pumping is 1×10⁵pa, i.e., therefore mold and combine the surface board and the compound bottom board. The thickness of the surface board 7 should be 2˜5 mm;

f, and then trim the surface board 7, after that, seal the edge of the product by hot melting to get the formed product.

Of course, besides EPS, the inner core 3 may adopts materials line EPP or IXPE, EPP means expandable polypropylene, IXPE means electronic cross-linked PE foam. While for said foamed plastic slice 2, besides, XPE material, it can also adopts IXPE, IXPE means electronic cross-linked PE foam, and when adopting IXPE as the material, the density should be 30˜60 Kg/m³.

The advantages of the plastic snowboard made by the above-mentioned methods are as below:

They have better impact resistance. Because the inner core acting as a framework is formed in the mold separately, the inner core is strong in structure easy in manufacture and reasonable in cost. In case of impact, the inner core will have fine elastic deformation rather then form deformation. With its improved impact resistance, the products can have complex appearances and exquisite structures.

What is claimed is:

1. A method for manufacturing a plastic snowboard comprising following processes:
a, make an inner core (3) in a shape of a product by foaming of plastic foam in a foaming mold;
b, take a plastic slice (2), apply a layer of PE (1) material on an undersurface of the plastic slice (2) to form a bottom board (6), and then apply a glue layer (5) on a upper surface of the plastic slice (2);
c, heat the bottom board (6) in an oven for 7˜15 minutes in temperature of 130˜180° C., then take out the bottom board (6) from the oven and place it in a mold, and then place the inner core (3) on the bottom board (6), making the glue layer (5) contact the inner core (3) and apply pressure on it, at the same time, carry out vacuum pumping between the undersurface of the bottom board (6) and the mold surface to mold the undersurface, a combination of the bottom board (6) and the inner core (3) forms a compound bottom board, after that, trim excessive material of the bottom board (6);
d, take a plastic film (4) and print patterns on a undersurface of it, adhere the undersurface of the printed plastic film (4) to the upper surface of the foamed plastic slice (2) by means of compound binding to form a surface board (7), and apply a glue layer (5) on the undersurface of the foamed plastic slice (2) with a plastic film on it;
e, heat the surface board (7) in the oven for 6˜15 minutes in temperature of 120˜180° C., then take out the surface board (7) from the oven and place it in a mold, make the glue layer (5) on the undersurface of the surface board (7) contact the inner core (3) of the upper surface of the compound bottom board and apply pressure on it, at the same time, carry out vacuum pumping between the surface board (7) and the mold surface to mold the surface board (7) and the compound bottom board;
f, and then trim the surface board (7), after that, seal the edge of the product by hot melting to get the formed product.

2. The manufacturing method of plastic snowboard as described in claim 1, wherein said inner core (3) adopts the materials of EPS, EPP or IXPE, EPS means expandable polystyrene, EPP means expandable polypropylene, IXPE means electronic cross-linked PE foam.

3. The manufacturing method of plastic snowboard as described in claim 1, wherein said foamed plastic slice (2) adopts XPE or IXPE, XPE means cross-linked PE foam, IXPE means electronic cross-linked PE foam.

4. The manufacturing method of plastic snowboard as described in claim 1, wherein a thickness of the surface board (7) or the bottom board (6) is 2˜5 mm.

5. The manufacturing method of plastic snowboard as described in claim 2, wherein the density of said IXPE material is 30˜60 Kg/m³.

6. The manufacturing method of plastic snowboard as described in claim 1, wherein said glue layer (5) is hot melt glue layer.

7. A manufacturing method of plastic snowboard as described in claim 1, wherein said inner core (3) is made in to a shape of the product from foam by steam heating in the foaming mold.

8. A manufacturing method of plastic snowboard as described in claim 1, wherein a layer of PE material is applied on undersurface of the foamed plastic slice (2) by a coating machine.

9. A manufacturing method of plastic snowboard as described in claim 1, wherein the range of said pressure is 65˜100 T.

10. A manufacturing method of plastic snowboard as described in claim 1, wherein the intensity of pressure of said vacuum pumping is 1×10⁵pa.

11. A plastic snowboard at least including:
An inner core (3);
A bottom board (6) made from a foamed plastic slice (2) and a layer of PE (1) material, the layer of PE (1) material is applied on the undersurface of the foamed plastic slice (2);
A surface board (7) made from a plastic film (4) and a foamed plastic slice (2), the plastic film (4) with print patterns on the undersurface is adhered on the upper surface of the foamed plastic slice (2) by means of compound binding;
The upper surface of the bottom board (6) and the undersurface of the surface board (7) are adhered with the surface of the inner core (3) respectively by the glue layer (5);
the inner core (3) is made in the shape of the product by foaming of plastic foam in a foaming mold.

12. The plastic snowboard as described in claim 11, wherein the inner core (3) adopts the materials of EPS, EPP or IXPE, EPS means expandable polystyrene, EPP means expandable polypropylene, IXPE means electronic cross-linked PE foam.

13. The plastic snowboard as described in claim 11, wherein the thickness of the surface board (7) or the bottom board (6) is 2˜5 mm.

14. The plastic snowboard as described in claim 12, wherein the density of said IXPE material is 30˜60 Kg/m³.
